(19) United States
(12) Patent Application Publication
(10) Pub. No.: US 2020/0409017 A1
(43) Pub. Date: Dec. 31, 2020

(54) LENS MODULE

(71) Applicant: AAC Optics Solutions Pte. Ltd., Singapore city (SG)

(72) Inventor: Chuandong Wei, Shenzhen (CN)

(21) Appl. No.: 16/914,367

(22) Filed: Jun. 28, 2020

(30) Foreign Application Priority Data
Jun. 28, 2019 (CN) PCT/CN2019/093918

(51) Int. Cl. G02B 7/02; H04N 5/225; B29C 45/26

(52) U.S. Cl. CPC G02B 7/021; B29C 45/26; H04N 5/2254

(57) ABSTRACT

The present invention provides a lens module, including a lens barrel and a lens group received in the lens barrel. The lens barrel includes a barrel body and a clamping boss, and the barrel body includes an inner wall close to a central axis of the barrel body and an outer wall opposite to the inner wall. The clamping boss is annular and provided around the outer wall. A first notch is provided on a side of the clamping boss facing away from the outer wall, and includes a first recessed surface, and second and third flat surfaces. The first recessed surface is provided between the second and third flat surfaces, and formed by recessing from the second flat surface and the third flat surface towards the central axis. The second and third flat surfaces are coplanar. A gate is provided on the first recessed surface.

### TECHNICAL FIELD

The present invention relates to the field of camera lens technology and, in particular to, a lens module.

### BACKGROUND

With the continuous development of science and technology, electronic devices have continuously developed towards intelligence. In addition to digital cameras, portable electronic devices such as tablet computers and mobile phones are also equipped with lens modules. The lens module in the related art generally includes a lens barrel and a lens received in the lens barrel.

The lens barrel of the lens module in the related art is generally manufactured using an injection molding process. Specifically, plasticized molten plastic is injected into a mold cavity from a gate of a mold, and a molded lens barrel is taken out of the mold after curing and shaping. Before taking out the lens barrel, superfluous plastic at the gate may protrude out of an outer side surface of the lens barrel after breaking, so as to form superfluous uneven protrusions on the outer side surface of the lens barrel, which seriously affects external cleanliness and production efficiency of the lens barrel.

Therefore, it is necessary to provide a new lens module.

### SUMMARY

The present invention provides a lens module that can solve the above technical problems.

A lens module includes a lens barrel and a lens group received in the lens barrel, and the lens barrel includes a barrel body and a clamping boss. The barrel body includes an inner wall close to a central axis of the barrel body and an outer wall opposite to the inner wall, and the clamping boss is annular and provided around the outer wall. At least one first notch is provided on a side of the clamping boss facing away from the outer wall, each of the at least one first notch includes a first recessed surface, a second flat surface and a third flat surface, the first recessed surface is provided between the second flat surface and the third flat surface, the second flat surface and the third flat surface are coplanar, the first recessed surface is formed by recessing from the second flat surface and the third flat surface towards the central axis, and a gate is provided on the first recessed surface.

In an embodiment, at least one first notch includes a plurality of first notches.

In an embodiment, the plurality of first notches includes four first notches.

In an embodiment, the first recessed surface is provided on an outer side of the outer wall facing away from the central axis.

In an embodiment, the first recessed surface is a flat surface.

In an embodiment, in a radius direction of the lens barrel, a distance from the outer wall to the first recessed surface is 0.05 mm.

In an embodiment, the gate is provided on one of the plurality of first notches.

In an embodiment, the lens barrel further includes a bottom boss provided at an image side of the clamping boss, the bottom boss and the clamping boss are adjacent to each other, the bottom boss is annular, and a side surface of the bottom boss facing away from the outer wall is closer to the outer wall than a side surface of the clamping boss facing away from the outer wall.

In an embodiment, at least one second notch is provided on a side of the bottom boss facing away from the outer wall, a position of each of the at least one second notch corresponds to a position of one of the at least one first notch, and the at least one second notch is closer to the outer wall than the first recessed surface of one of the at least one first notch.

In an embodiment, each of the at least one second notch is a flat surface.

In the lens barrel of the lens module of the present invention, a circle of clamping bosses is provided on the outer wall of the barrel body, the first notch is provided at any position on a side of the clamping boss facing away from the outer wall, and the gate is provided on the first recessed surface. In this way, after the lens barrel is cured and shaped in the mold, even if there will be a little superfluous uneven protrusion when plastic at the gate breaks, the uneven protrusion will be hidden in the first notch and will not protrude out of the first notch, that is, it will not protrude out of the second flat surface and the third flat surface. Therefore, when using the second flat surface and the third flat surface to clamp the lens barrel, it will not be affected by the residual gate, and external cleanliness and production efficiency of the lens barrel will not be affected.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic diagram of an overall structure of a lens barrel;

FIG. 2 is a side view of a lens barrel;

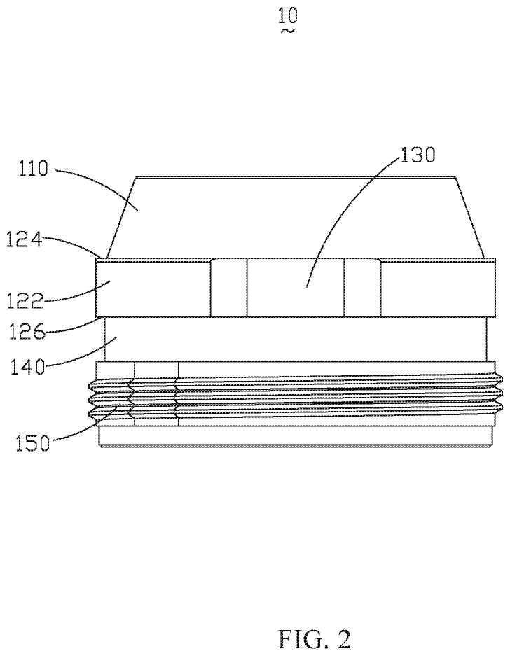

FIG. 3 is a top view of a lens barrel; and

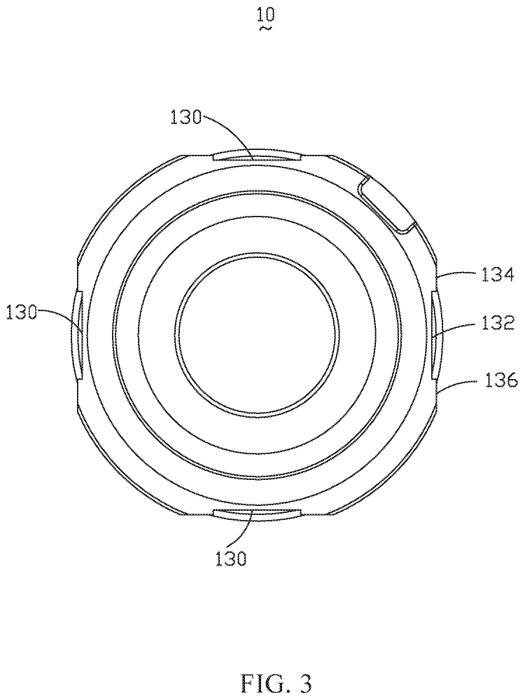

FIG. 4 is a schematic diagram of an overall structure of a lens barrel.

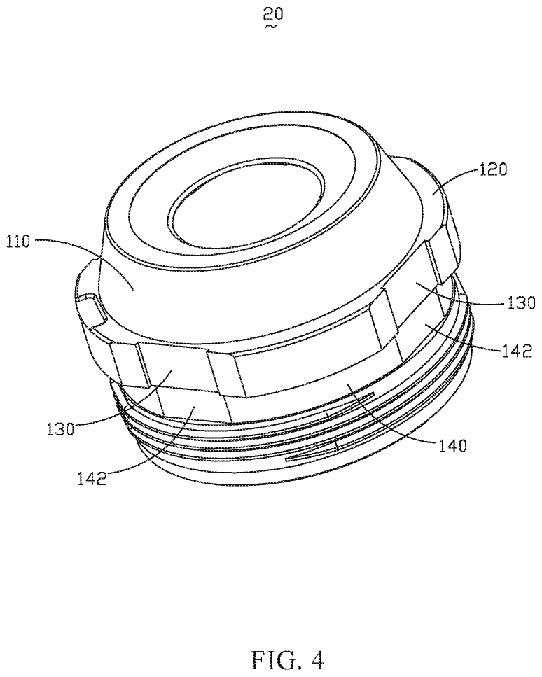

### DESCRIPTION OF EMBODIMENTS

The present invention will be further illustrated with reference to the accompanying drawings and the embodiments.

It should be noted that all directional indications (such as up, down, left, right, front, back . . . ) in the embodiments of the present invention are only used to explain relative positional relationship, movement, etc. of various components under a specific posture (as shown in the drawings), if the specific posture changes, the directional indications also change accordingly.

In addition, descriptions related to “first”, “second”, etc. in the present invention are for descriptive purposes only and cannot be understood as indicating or implying their relative importance or implicitly indicating the number of technical features indicated. Thus, features defined as “first” and “second” may include at least one of the features explicitly or implicitly. In addition, the technical solutions between the various embodiments can be combined with each other, but they must be based on the ability of those skilled in the art to realize. When the combination of the technical solutions contradicts or cannot be achieved, it should be considered that the combination of such technical solutions does not exist, nor within the protection scope claimed by the present invention.

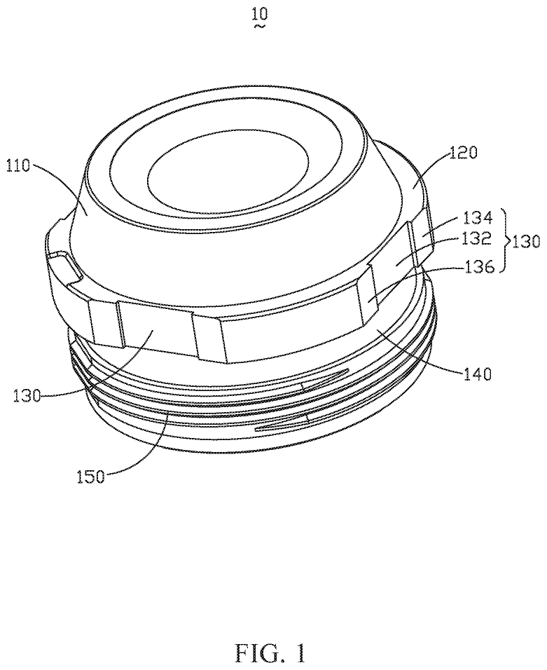

Referring to FIG. 1, the present invention provides a lens module, and the lens module includes a lens barrel 10 and a lens group received in the lens barrel 10. The lens barrel 10 is of a barrel structure with two ends being open.

The lens barrel 10 includes a barrel body 110 and a clamping boss 120, and the barrel body 110 has a central axis. The barrel body 110 includes an inner wall close to the central axis and an outer wall arranged opposite to the inner wall. The clamping boss 120 is annular and provided around on the outer wall. Since the lens barrel 10 is basically injection molded, the clamping boss 120 and the barrel body 110 are formed into one piece, and the clamping boss 120 can be regarded as being formed by the outer wall projecting towards a direction facing away from the central axis. The clamping boss 120 includes an outer side surface 122 facing away from the outer wall, and a first notch 130 is provided on the outer side surface 122.

The first notch 130 in the present embodiment includes a first recessed surface 132, a second flat surface 134, and a third flat surface 136. The first recessed surface 132 is disposed between the second flat surface 134 and the third flat surface 136, and the second flat surface 134 and the third flat surface 136 are coplanar. The first recessed surface 132 is recessed from the second flat surface 134 and the third flat surface 136 in a direction close to the central axis, and a gate is provided on the first recessed surface 132.

The lens barrel 10 in the present embodiment is provided with a circle of clamping bosses 120 on the outer wall of the barrel body 110, and the first notch 130 is provided at any position on the outer side surface 122 of the clamping boss 120, since a recessing degree of the first recessed surface 132 in the first notch 130 is deeper, and the gate is provided on the first recessed surface 132, in such a manner that after the lens barrel 10 is cured and shaped in the mold, even if there will be a little superfluous uneven protrusion when plastic at the gate breaks, the uneven protrusion will be hidden in the first notch 130 and will not protrude out of the first notch 130. That is, it will not protrude out of the second flat surface 134 and the third flat surface 136, in such a manner that when using the second flat surface 134 and the third flat surface 136 to clamp the lens barrel 10, it will not be affected by the residual gate, and external cleanliness and production efficiency of the lens barrel 10 will not be affected.

There can be a plurality of first notches 130, and the plurality of first notches 130 are evenly arranged on the clamping boss 120. When injection molding the lens barrel 10, a gate can be provided at each of the first notches 130 molten plastic can enter a mold cavity of the mold simultaneously from multiple gates, and the molding performance is optimized according to a shape and a size of the lens barrel. In an embodiment, the gate can be provided on one of the first notches 130.

In an embodiment, the plurality of first notches 130 includes four first notches 130, the four first notches 130 are evenly arranged along a periphery of the clamping boss 120, and the gate is provided on one of the four first notches 130. The lens barrel 10 of the present embodiment has excellent molding performance.

The first notch 130 penetrates the clamping boss 120 in a direction parallel to the central axis of the barrel body 110, That is to say, along an axial direction of the barrel body, the first notch is a through-groove structure, and this structure facilitates setting of the mold. n other embodiments, the first notch 130 does not penetrate the clamping boss 120, and it is only necessary to dig a groove on an outer side surface 122 of the clamping boss 120.

The outer side surface 122 and an end of the second flat surface 134 facing away from the first recessed surface 132 are connected to each other, the outer side surface 122 and an end of the third flat surface 136 facing away from the first recessed surface 132 are connected to each other, and the first recessed surface 132 is provided at an outer side of the outer wall facing away from the central axis of the lens barrel 10. At the first notch 130, the clamping boss 120 also protrudes out of the outer wall, and the protruding portion facilitates clamping with the clamping tool after the lens barrel 10 is injection molded.

In an embodiment, the first recessed surface 132 is a flat surface, the first recessed surface 132, the second flat surface 134, and the third flat surface 136 are parallel, and the first recessed surface 132 is disposed closer to the outer wall than the second flat surface 134 and the third flat surface 136. A distance between the first recessed surface 132 and the second flat surface 134 is 0.05 mm. In a radius direction of the lens barrel 10, a distance from the outer wall outward to the first recessed surface 132 is 0.05 mm. In another embodiment, the first recessed surface 132 is a flat surface, and an included angle is formed between the first recessed surface 132 and the second flat surface 134, that is, the first recessed surface 132 can be inclined with respect to the second flat surface 134.

In other embodiments, the first recessed surface 132 can be a curved surface.

In an embodiment, the lens barrel 10 further includes a bottom boss 140. The bottom boss 140 is located at an image side of the clamping boss 120, and the bottom boss 140 is arranged adjacent to the clamping boss 120. A side surface of the bottom boss 140 facing away from the outer wall is closer to the outer wall than a side surface of the clamping boss 120 facing away from the outer wall. That is, in a direction outward the radius direction of the barrel body 110, the clamping boss 120 is higher than the bottom boss 140, so that after the lens barrel 10 is injection molded in the mold, the clamping tool can clamp the clamping boss 120, and a tip end of the clamping tool will not abut against the bottom boss 140, which not only facilitates the clamping tool to clamp, but also prevents the clamping tool from directly contacting the outer wall of the barrel body 110, thereby preventing the clamping tool from scratching the outer wall.

In an embodiment, the bottom boss 140 is annular, the bottom boss 140 and the clamping boss 120 are arranged in parallel, and a side surface of the bottom boss 140 facing away from the outer wall is closer to the outer wall than the first recessed surface 132. In other words, an outer diameter of the bottom boss 140 is smaller than a distance between the two opposite first recessed surfaces 132, and in the radius direction of the barrel body 110, the bottom boss 140 is lower than the first notch 130. With such configuration, it is convenient for ultrasonic waves to shake off the gate after the lens barrel 10 is molded in the mold.

In the lens barrel 20 of another embodiment, the bottom boss 140 is annular, and a side of the bottom boss 140 facing away from the outer wall is provided with a second notch 142. A position of the second notch 142 corresponds to a position of the first notch 130, and the second notch 142 is closer to the outer wall than the first recessed surface 132. With such configuration, it is convenient for the ultrasonic waves to shake off the gate after the lens barrel 10 is molded in the mold.

In an embodiment, the clamping boss 120 further includes a first connection surface 124 and a second connection surface 126 that are connected to the outer side surface 122, both the first connection surface 124 and the second connection surface 126 are perpendicular to the optical axis, the first connection surface 124 is close to an object side, and the second connection surface 126 is close to the image side.

The lens barrel 10 can be also provided with a thread portion 150, and the thread portion 150 is provided close to the image side of the lens barrel 10. The thread portion 150 can be used to connect the lens barrel 10 with an external member.

It should be noted that, the above are merely embodiments of the present invention, those skilled in the art can make improvements without departing from the inventive concept of the present invention, however, these improvements shall belong to the protection scope of the present invention.

What is claimed is:

1. A lens module, comprising:
a lens barrel; and
a lens group received in the lens barrel,
wherein the lens barrel comprises a barrel body and a clamping boss, the barrel body comprises an inner wall close to a central axis of the barrel body and an outer wall opposite to the inner wall, and the clamping boss is annular and provided around the outer wall; and
at least one first notch is provided on a side of the clamping boss facing away from the outer wall, each of the at least one first notch comprises a first recessed surface, a second flat surface and a third flat surface, the first recessed surface is provided between the second flat surface and the third flat surface, the second flat surface and the third flat surface are coplanar, the first recessed surface is formed by recessing from the second flat surface and the third flat surface towards the central axis, and a gate is provided on the first recessed surface.

2. The lens module as described in claim 1, wherein the at least one first notch comprises a plurality of first notches.

3. The lens module as described in claim 2, wherein the plurality of first notches comprises four first notches.

4. The lens module as described in claim 1, wherein the first recessed surface is provided on an outer side of the outer wall facing away from the central axis.

5. The lens module as described in claim 4, wherein the first recessed surface is a flat surface.

6. The lens module as described in claim 5, wherein in a radius direction of the lens barrel, a distance from the outer wall to the first recessed surface is 0.05 mm.

7. The lens module as described in claim 2, wherein the gate is provided on one of the plurality of first notches.

8. The lens module as described in claim 1, wherein the lens barrel further comprises a bottom boss provided at an image side of the clamping boss, the bottom boss and the clamping boss are adjacent to each other, the bottom boss is annular, and a side surface of the bottom boss facing away from the outer wall is closer to the outer wall than a side surface of the clamping boss facing away from the outer wall.

9. The lens module as described in claim 8, wherein at least one second notch is provided on a side of the bottom boss facing away from the outer wall, a position of each of the at least one second notch corresponds to a position of one of the at least one first notch, and each of the at least one second notch is closer to the outer wall than the first recessed surface of one of the at least one first notch.

10. The lens module as described in claim 8, wherein, each of the at least one second notch is a flat surface.
